(19) United States
(12) Patent Application Publication
(10) Pub. No.: US 2012/0228955 A1
(43) Pub. Date: Sep. 13, 2012

(54) TRANSMISSION COIL FOR WIRELESS POWER TRANSMISSION

(75) Inventors: Yuki Endo, Tokyo (JP); Yasuo Furukawa, Tokyo (JP)

(73) Assignee: ADVANTEST CORPORATION, Tokyo (JP)

(21) Appl. No.: 13/407,576

(22) Filed: Feb. 28, 2012

Related U.S. Application Data
(60) Provisional application No. 61/449,835, filed on Mar. 7, 2011.

(51) Int. Cl. H02J 17/00

(52) U.S. Cl. 307/104

(57) ABSTRACT

A transmission coil is mounted in a wireless power supply apparatus, and is configured to transmit an electric power signal including any one from among an electric field, a magnetic field, and an electromagnetic field. The transmission coil includes a loop coil and a magnetic member. The magnetic member is configured to cover a particular portion of the loop coil. For example, the loop coil may be configured to have a shape in which a first side and a second side are substantially in parallel with each other. The magnetic member may be configured to cover the first side of the loop coil.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power transmission can be classified into three principal methods using an electromagnetic induction, an electromagnetic wave reception, and an electric field/magnetic field resonance.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%.

In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (see Non-patent document 1).

FIG. 1 is a diagram which shows an example of a wireless power supply system. A wireless power supply system 1100 includes a wireless power supply apparatus 1200 and a wireless power receiving apparatus 1300.

The wireless power supply apparatus 1200 includes a transmission coil L1, a resonance capacitor C1, and an AC power supply 10. The AC power supply 10 is configured to generate an electric signal S2 having a transmission frequency f1. The resonance capacitor C1 and the transmission coil L1 form a resonance circuit. The resonance frequency of the resonance circuit thus formed is tuned to the frequency of the electric signal S2. The transmission coil L1 is configured to transmit an electric power signal S1.

The wireless power receiving apparatus 1300 includes a reception coil L2, a resonance capacitor C2, and a load circuit 20. The resonance capacitor C2, the reception coil L2, and the load circuit 20 form a resonance circuit. The resonance frequency of the resonance circuit thus formed is tuned to the frequency of the electric power signal S1.

### RELATED ART DOCUMENTS

### Patent Documents

[Non-patent document 1]

A. Karalis, J. D. Joannopoulos, M. Soljacic, “Efficient wireless non-radiative mid-range energy transfer” ANNALS of PHYSICS Vol. 323, Jan 2008, pp. 34-48.

FIG. 2 is a diagram which shows a magnetic field generated by a loop coil. A loop coil 30 includes two facing sides 32 and 34. The loop coil 30 is configured such that the direction in which the current flows through the first side 32 is the opposite of the direction in which the current flows through the second side 34. The magnetic field dH generated by a current element Ids on the first side 32 and a current element Ids on the second side 34 is represented by the following Expression (1) using the Biot-Savart law.

$$d \vec{H} = \frac{1}{4 π} ( \frac{Id \vec{s} \times \vec{r}}{{\vert \vec{r} \vert}^{3}} - \frac{Id \vec{s} \times \vec{{r}_{d}}}{{\vert \vec{{r}_{d}} \vert}^{3}} ) \qquad [ Expression 1 ]$$

In a case in which the loop coil 30 has a sufficiently large width (diameter) x, the relation rd>>r is satisfied, and accordingly, of the magnetic field H at the position P, the component generated due to the current that flows through the second side 34 becomes dominant. On the other hand, if the loop coil 30 has a small width x, rd is approximately equal to r. In this case, the magnetic field component generated due to the current that flows through the first side 32 and the magnetic field generated due to the current that flows through the second side 34 cancel each other out, which reduces the magnetic field at the point P.

Thus, it can be said that, with the magnetic field resonance method, the transmission distance is proportional to the diameter of the transmission coil L1. Accordingly, such an arrangement requires the transmission coil L1 to have an increased diameter x in order to provide an increased transmission distance. For example, if the transmission distance is on the order of double the diameter x of the transmission coil L1, in order to provide a transmission distance of 2 m, such an arrangement requires a transmission coil L1 having a diameter of 1 m. Such an arrangement leads to a problem of installation location constraints. Thus, the size of the transmission coil must be reduced before wireless power supply transmission becomes popular.

There are two known methods for providing a small-size antenna. The first method is a method in which an antenna is formed to have a short length with respect to the transmission wavelength, and an inductive impedance is connected to the antenna so as to cancel out impedance mismatching that occurs due to its conductive impedance, thereby providing impedance matching. The second method is a method using wavelength reduction in which the antenna is formed of a material having a high dielectric constant and a high magnetic permeability. However, such methods can be applied to only electromagnetic wave reception type power transmission employing electromagnetic field radiation. That is to say, such methods cannot be applied to electric field/magnetic field resonance type power transmission employing a near-field component.

### SUMMARY OF THE INVENTION

The present invention has been made in order to solve such a problem. Accordingly, it is an exemplary purpose of the present invention to provide a reduction in the size of a transmission coil employed in electric field/magnetic field resonance type wireless power transmission.

An embodiment of the present invention relates to a transmission coil for a wireless power supply apparatus configured to transmit an electric power signal including any one from among an electric field, a magnetic field, and an electromagnetic field. The transmission coil comprises: a loop coil; and a magnetic member configured to cover a portion of the loop coil.

The directions in which the respective currents flow through the two facing portions of the loop coil are opposite to one another. Accordingly, at the position of the receiving antenna, which is away from the loop coil, the magnetic field generated by one of the aforementioned currents is canceled out by the magnetic field generated by the other of the aforementioned currents. By covering a particular portion of the loop coil with a magnetic member, such an arrangement is capable of virtually increasing the distance between this portion and the receiving antenna. Thus, such an arrangement provides an increased magnetic field at the position of the receiving antenna, as compared with an arrangement that does not employ such a magnetic member. In other words, in comparison with a loop coil of which no portion is covered with such a magnetic member, such an arrangement requires a loop coil having a much smaller size to provide a magnetic field of the same magnitude.

Also, the loop coil may include a first side and a second side that are arranged substantially in parallel with each other. Also, the magnetic member may be configured to cover the first side of the loop coil.

Another embodiment of the present invention also relates to a transmission coil. The transmission coil comprises: a first loop coil; a second loop coil; a first magnetic member configured to cover a portion of the first loop coil that is farther from the second loop coil; and a second magnetic member configured to cover a portion of the second loop coil that is farther from the first loop coil.

With such a transmission coil, by providing such a portion of the first loop coil that is not covered with the magnetic member, and by providing such a portion of the second loop coil that is not covered with the magnetic member, such an arrangement is capable of generating a magnetic field with a strong magnitude.

Also, the first loop coil may be configured to have a first side and a second side arranged substantially in parallel with each other. Also, the second loop coil may be configured to have a third side and a fourth side arranged substantially in parallel with each other. Also, the first magnetic member may be configured to cover the side from among the first side and the second side that is farther from the second loop coil. Also, the second magnetic member may be configured to cover the side from among the third side and the fourth side that is farther from the first loop coil.

Yet another embodiment of the present invention also relates to a transmission coil. The transmission coil comprises: a solenoid coil; and a magnetic member configured to cover a portion of the solenoid coil.

Also, the solenoid coil may be configured to have a cross-sectional shape wherein a first side and a second side are arranged substantially in parallel with each other. Also, the magnetic member may be configured to cover a portion of the solenoid coil that corresponds to the first side.

With such an embodiment, by covering the first side of such a cross-sectional shape with the magnetic member, such an arrangement is capable of virtually increasing the distance between the first side and the position of the receiving antenna. Thus, such an arrangement provides an increased magnetic field at the position of the receiving antenna, as compared with an arrangement that does not employ such a magnetic member. In other words, in comparison with a loop coil of which no portion is covered with such a magnetic member, such an arrangement requires a loop coil having a much smaller size to provide a magnetic field of the same magnitude.

Yet another embodiment of the present invention relates to a wireless power supply apparatus. The wireless power supply apparatus comprises: a transmission coil according to any one of the aforementioned embodiments; a resonance capacitor arranged in series with the transmission coil; and a power supply configured to supply a driving signal to a resonance circuit formed of the transmission coil and the resonance capacitor.

Yet another embodiment of the present invention relates to a wireless power supply system. The wireless power supply system comprises: a wireless power supply apparatus according to any one of the aforementioned embodiments; and a wireless power receiving apparatus configured to receive an electric power signal from the wireless power supply apparatus.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an example of a wireless power supply system;

FIG. 2 is a diagram which shows a magnetic field generated by a loop coil;

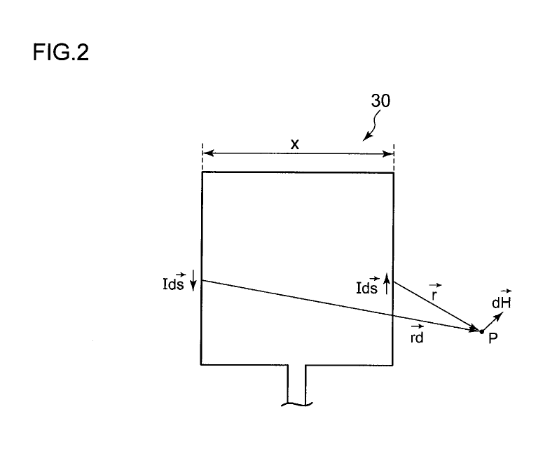

FIG. 3 is a diagram which shows a configuration of a transmission coil of a wireless power supply apparatus according to an embodiment;

FIG. 4 is a diagram which shows a loop coil that is equivalent to the transmission coil shown in FIG. 3;

FIG. 5 is a diagram which shows a transmission coil used in simulation;

FIG. 6A is a diagram which shows a magnetic field generated by a loop coil shown in FIG. 5, and FIG. 6B is a diagram which shows a magnetic field if the magnetic permeability of the magnetic member shown in FIG. 5 was the same as that of the air;

FIG. 7A is a diagram which shows a transmission coil including multiple loop coils, and FIG. 7B is an equivalent circuit diagram of the transmission coil shown in FIG. 7A; and

FIG. 8A is a perspective view of a transmission coil according to a modification, and FIG. 8B is a cross-sectional view from the top of the transmission coil.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

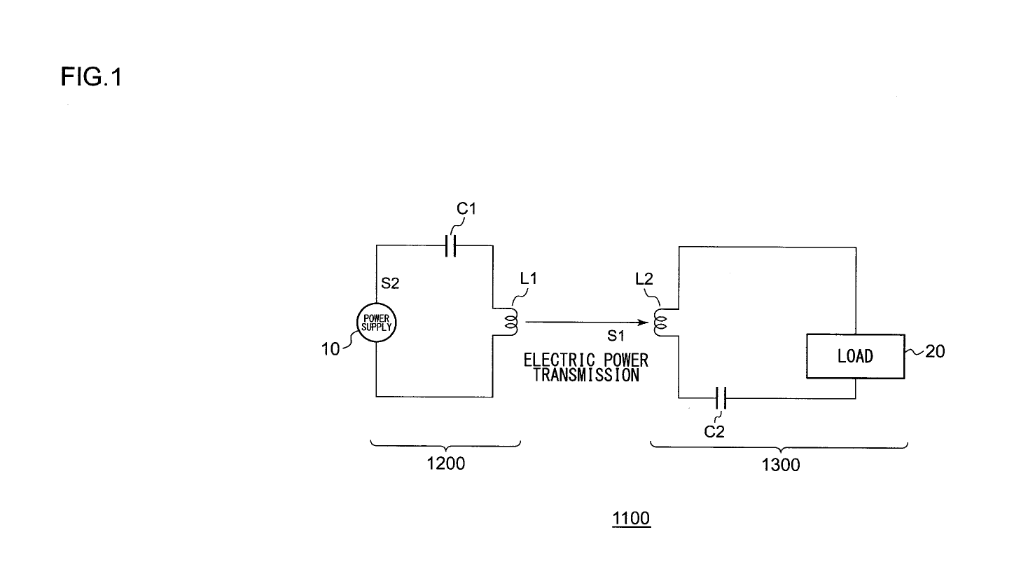

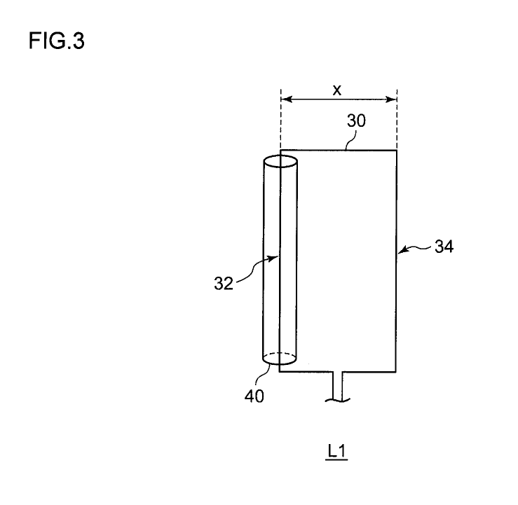

FIG. 3 is a diagram which shows a configuration of a transmission coil included in a wireless power supply apparatus according to an embodiment. Such a transmission coil L1 can be employed in the wireless power supply apparatus as shown in FIG. 1.

The transmission coil L1 includes a loop coil 30 and a magnetic member 40 which is made of a magnetic material and arranged such that it covers a particular portion of the loop coil 30. Specifically, the loop coil 30 includes a first side 32 and a second side 34 arranged substantially in parallel with each other. The distance between the first side 32 and the second side 34 is represented by “x”. The loop coil 30 has a rectangular shape, the long sides of which correspond to the first side 32 and the second side 34. The magnetic member 40 is formed such that it covers the first side 32 of the loop coil 30. For example, the magnetic member 40 is configured to have a cylindrical shape with a diameter φ formed such that its axis is aligned with the first side 32. It should be noted that the shape of the magnetic member 40 is not restricted in particular. Also, the magnetic member 40 may be configured to have other shapes, examples of which include a quadrangular block shape, an ellipsoidal shape, etc.

The above is the configuration of the transmission coil L1. Next, description will be made below regarding the operation thereof.

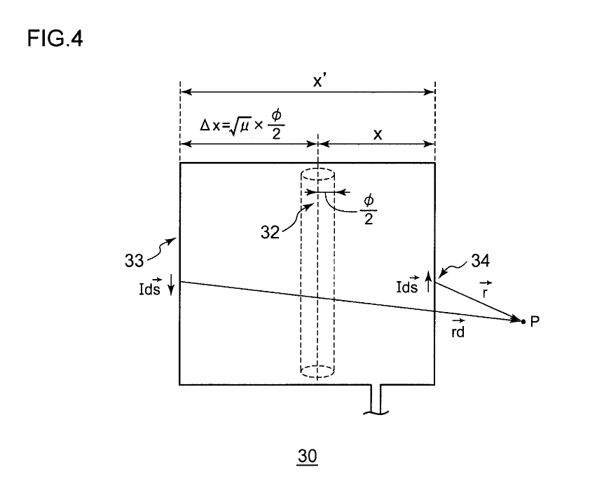

FIG. 4 is a diagram which shows a loop coil 30 which is equivalent to the transmission coil L1 shown in FIG. 3. The magnetic member provides the space compression effect, which allows the first side 32 thus covered with the magnetic member 40 arranged at the distance x away from the second side 34 to be regarded as being equivalent to the first side 33 that is not covered with the magnetic member 40 arranged at the distance (x+Δx) away from the second side 34. That is to say, by covering the first side 32 with the magnetic member 40, the first side 32 can be virtually arranged at the distance Δx away from the actual position. With the magnetic permeability of the magnetic member 40 as μ, the distance Δx is represented by approximately Δx=√μ•φ/2. As an example, in a case in which x=30 mm, φ=10 mm, and μ=500, the distance Δx is 112 mm, and accordingly, the effective width x′ of the loop coil 30 is 142 mm. The transmission distance is on the order of the width x′. Thus, such an arrangement is capable of providing a transmission distance of 142 mm using such a loop coil 30 having a width of only 30 mm.

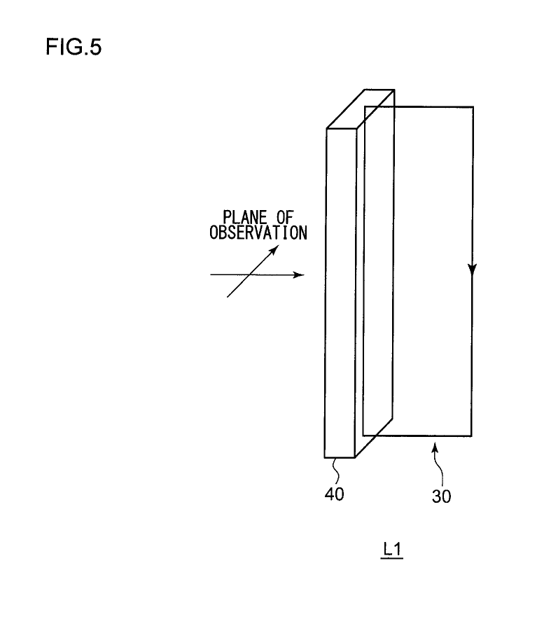

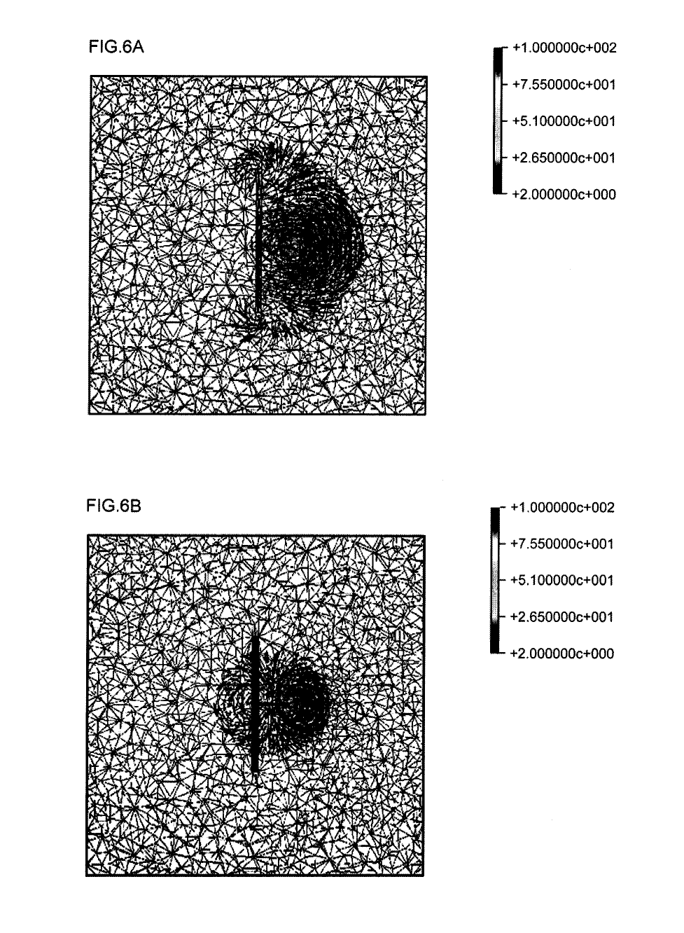

Description will be made regarding simulation results with respect to the loop coil 30 according to the embodiment. FIG. 5 is a diagram which shows a transmission coil L1 used in a simulation. In FIG. 5, the magnetic member 40 is configured to have a quadrangular block shape. FIG. 6A is a diagram which shows a magnetic field generated by the loop coil 30 shown in FIG. 5. FIG. 6B is a diagram which shows the magnetic field if the magnetic permeability μ of the magnetic member 40 shown in FIG. 5 was the same as that of the air. FIGS. 6A and 6B each show the magnetic field generated on the plane of observation shown in FIG. 5.

First, description will be made with reference to FIG. 6B. Such an arrangement shown in FIG. 6B can be regarded as being equivalent to an arrangement that does not include the magnetic member 40. In this case, such an arrangement generates a symmetrical magnetic field with the first side 32 and the second side 34 as the respective centers. Referring to FIG. 6A, it can be understood that, by providing the magnetic member 40, such an arrangement generates the magnetic field such that it is concentrated on the right side of the first side 32, thereby providing a magnetic field transmission distance that is longer than that shown in FIG. 6B.

As described above, by covering the first side 32 of the loop coil 30 with the magnetic member 40, such an arrangement is capable of providing the loop coil 30 with the effective width x that is longer than the actual width x. In other words, such an arrangement provides an increased transmission distance using the loop coil 30 having a width (diameter) that is smaller than that of conventional arrangements. Thus, such an arrangement provides the loop coil 30 with a small size.

By providing such a small-size loop coil 30, such an arrangement facilitates installation, and provides reduced costs for delivery and so forth.

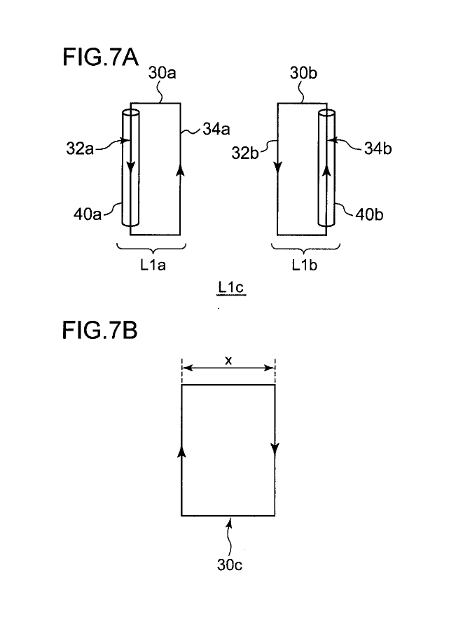

FIG. 7A is a diagram which shows a transmission coil L1c including multiple loop coils 30. FIG. 7B is an equivalent circuit diagram of the transmission coil L1c shown in FIG. 7A. The transmission coil L1c includes two transmission coils L1a and L1b. The transmission coils L1a and L1b each have the same configuration as described above. That is to say, the first transmission coil L1a includes a first loop coil 30a and a first magnetic member 40a. The first loop coil 30a includes a first side 32a and a second side 34a arranged substantially in parallel with each other. Of the first side 32a and the second side 34a, the first side 32a, which is the side farther from the second loop coil 30b, is covered with the first magnetic member 40a.

The second transmission coil L1b includes a second loop coil 30b and a second magnetic member 40b. The second loop coil 30b is configured to have a shape having a third side 32b and a fourth side 34b arranged substantially in parallel with each other.

The third side 32b and the fourth side 34b are preferably arranged on substantially the same plane as the first side 32a and the second side 34a of the first loop coil 30a, and are preferably arranged substantially in parallel with the first side 32a and the second side 34a.

Of the third side 32b and the fourth side 34b, the fourth side 34b, which is the side farther from the first loop coil 30a, is covered with the second magnetic member 40b.

The first loop coil 30a and the second loop coil 30b are each configured to have a rectangular shape, with two long sides that respectively correspond to the first side 32a and the second side 34a, and other long sides that respectively correspond to the third side 32b and the fourth side 34b.

The transmission coil L1c shown in FIG. 7A can be regarded as being equivalent to a loop coil 30c in which the facing sides are the second side 34a and the third side 32b. The loop coils 30a and 30b are configured independently, and can be installed separately, thereby allowing the loop coils 30a and 30b to be arranged with a long distance between them. For example, if the loop coil 30a is installed in one corner of a room, and the loop coil 30b is installed in another corner of the same room, such an arrangement provides the distance x=2 to 3 m.

If a loop coil having a width of 2 to 3 m is installed in a room, such an arrangement requires major installation work. In contrast, such an arrangement employing the transmission coil L1c shown in FIG. 7A requires only minor installation work in which the transmission coils L1a and L1b are arranged at different positions in the room. Thus, such an arrangement dramatically facilitates installation.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

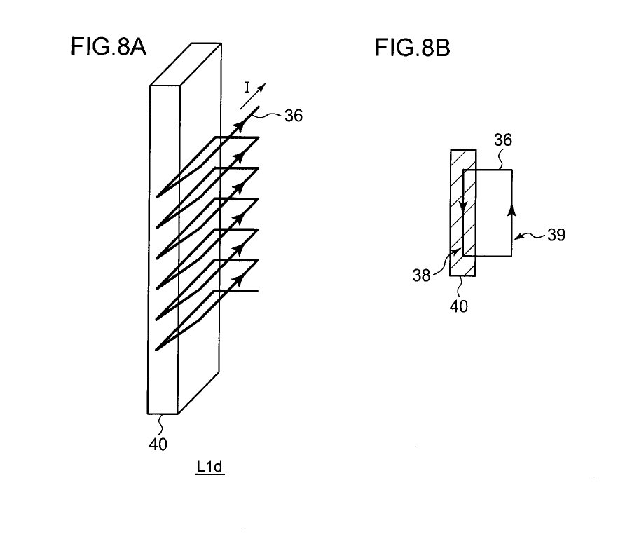

Description has been made in the embodiment regarding the transmission coil L1 employing the loop coil 30. However, the shape of the coil is not restricted to such an arrangement. FIG. 8A is a perspective view of a transmission coil L1d according to a modification. FIG. 8B is a cross-sectional view from the top of the transmission coil L1d. The transmission coil L1d includes a solenoid coil 36 and a magnetic member 40. The solenoid coil 36 includes a first side 38 and a second side 39 arranged such that their cross-sections are substantially in parallel with each other. The magnetic member 40 covers a portion of the solenoid coil 36 that corresponds to the first side 38.

The above is the configuration of the transmission coil L1d. With such a transmission coil L1d, the magnetic field generated by the portion of the solenoid coil 36 that is covered by the magnetic member 40 is reduced. Thus, such an arrangement provides an increased transmission distance as compared with an arrangement that does not employ such a magnetic member 40. Alternatively, such an arrangement allows the transmission coil L1d to be provided with a reduced size.

With such a transmission coil L1 shown in FIG. 3, the shape of the loop coil 30 is not restricted to such a rectangular shape. Rather, the loop coil 30 may be configured to have a desired shape. By covering a portion of the loop coil with the magnetic member 40, such an arrangement provides an increased magnetic field transmission distance, or otherwise allows the transmission coil L1 to be provided with a reduced size. For example, in a case in which the loop coil 30 is configured to have a circular shape, an arc portion that corresponds to a central angle α may be covered with the magnetic member 40.

Similarly, the cross-sectional shape of the solenoid coil 36 is not restricted to such a rectangular shape. Rather, the solenoid coil 36 may be configured to have a desired cross-sectional shape. By covering a portion of the solenoid coil with the magnetic member 40, such an arrangement provides an increased magnetic field transmission distance, or otherwise allows the transmission coil L1 to be provided with a reduced size.

While the preferred embodiments of the present invention have been described using specific terms, such description is for illustrative purposes only, and it is to be understood that changes and variations may be made without departing from the spirit or scope of the appended claims.

What is claimed is:

1. A transmission coil for a wireless power supply apparatus configured to transmit an electric power signal including any one from among an electric field, a magnetic field, and an electromagnetic field, the transmission coil comprising:
a loop coil; and
a magnetic member configured to cover a portion of the loop coil.

2. A transmission coil according to claim 1, wherein the loop coil includes a first side and a second side that are arranged substantially in parallel with each other,
and wherein the magnetic member is configured to cover the first side of the loop coil.

3. A transmission coil according to claim 2, wherein the loop coil is configured to have a rectangular shape the long sides of which correspond to the first side and the second side.

4. A transmission coil for a wireless power supply apparatus configured to transmit an electric power signal including any one from among an electric field, a magnetic field, and an electromagnetic field, the transmission coil comprising:
a first loop coil;
a second loop coil;
a first magnetic member configured to cover a portion of the first loop coil that is farther from the second loop coil; and
a second magnetic member configured to cover a portion of the second loop coil that is farther from the first loop coil.

5. A transmission coil according to claim 4, wherein the first loop coil is configured to have a first side and a second side arranged substantially in parallel with each other,
and wherein the second loop coil is configured to have a third side and a fourth side arranged substantially in parallel with each other,
and wherein the first magnetic member is configured to cover the side from among the first side and the second side that is farther from the second loop coil,
and wherein the second magnetic member is configured to cover the side from among the third side and the fourth side that is farther from the first loop coil.

6. A transmission coil according to claim 5, wherein the first loop coil and the second loop coil are each configured to have a rectangular shape the respective long sides of which correspond to the first side, the second side, the third side, and the fourth side.

7. A transmission coil for a wireless power supply apparatus configured to transmit an electric power signal including any one of an electric field, a magnetic field, and an electromagnetic field, the transmission coil comprising:
a solenoid coil; and
a magnetic member configured to cover a particular portion of the solenoid coil.

8. A transmission coil according to claim 7, wherein the solenoid coil is configured to have a cross-sectional shape wherein a first side and a second side are arranged substantially in parallel with each other,
and wherein the magnetic member is configured to cover a portion of the solenoid coil that corresponds to the first side.

9. A transmission coil according to claim 8, wherein the solenoid coil is configured to have a rectangular cross-sectional shape the long sides of which correspond to the first side and the second side.

10. A transmission coil for a wireless power supply apparatus configured to transmit an electric power signal including any one of an electric field, a magnetic field, and an electromagnetic field, the transmission coil comprising:
an antenna coil; and
a magnetic member configured to cover a particular portion of the antenna coil.

11. A wireless power supply apparatus comprising:
a transmission coil according to claim 1;
a resonance capacitor arranged in series with the transmission coil; and
a power supply configured to supply a driving signal to a resonance circuit formed of the transmission coil and the resonance capacitor.

12. A wireless power supply system comprising:
a wireless power supply apparatus according to claim 10; and
a wireless power receiving apparatus configured to receive an electric power signal from the wireless power supply apparatus.

13. A wireless power supply apparatus comprising:
a transmission coil according to claim 4;
a resonance capacitor arranged in series with the transmission coil; and
a power supply configured to supply a driving signal to a resonance circuit formed of the transmission coil and the resonance capacitor.

14. A wireless power supply system comprising:
a wireless power supply apparatus according to claim 13; and
a wireless power receiving apparatus configured to receive an electric power signal from the wireless power supply apparatus.

15. A wireless power supply apparatus comprising:
a transmission coil according to claim 7;
a resonance capacitor arranged in series with the transmission coil; and
a power supply configured to supply a driving signal to a resonance circuit formed of the transmission coil and the resonance capacitor.

16. A wireless power supply system comprising:
a wireless power supply apparatus according to claim 15; and
a wireless power receiving apparatus configured to receive an electric power signal from the wireless power supply apparatus.

17. A wireless power supply apparatus comprising:
a transmission coil according to claim 10;
a resonance capacitor arranged in series with the transmission coil; and
a power supply configured to supply a driving signal to a resonance circuit formed of the transmission coil and the resonance capacitor.

18. A wireless power supply system comprising:
a wireless power supply apparatus according to claim 17; and
a wireless power receiving apparatus configured to receive an electric power signal from the wireless power supply apparatus.
